(19) United States
(12) Patent Application Publication
(10) Pub. No.: US 2019/0168347 A1
(43) Pub. Date: Jun. 6, 2019

(54) ROTARY TOOL STOWAGE SYSTEM

(71) Applicants: Payton Graham, Minerva, OH (US); Tony Randal, Minerva, OH (US)

(72) Inventors: Payton Graham, Minerva, OH (US); Tony Randal, Minerva, OH (US)

(21) Appl. No.: 15/833,771

(22) Filed: Dec. 6, 2017

(51) Int. Cl. B23Q 3/157; B23Q 3/155

(52) U.S. Cl. CPC B23Q 3/15722; B23Q 3/15553; B23Q 3/15526; B23Q 3/15546

(57) ABSTRACT

A socket tool storage system comprises a multi-tiered arrangement of a plurality of socket shelves in a vertical configuration, each socket shelf comprised of a plurality of socket drive attachments to receive sockets, with non-identical spacing between the drive attachments. A central shaft facilitates attaching the socket shelves in the vertical configuration, one socket shelf over a next socket shelf, each socket shelf attached to rotate on the central shaft. A ratchet and extension holder attached to the central shaft to stow a plurality of ratchets and extensions, the ratchet and extension holder comprising holes of at least two diameters. A back shroud attaches to a base supporting the central shaft.

### CROSS-REFERENCE TO RELATED APPLICATION(S)

Not applicable

### BACKGROUND OF THE INVENTION

### 1. Field of Invention

The present invention relates to the field of tool stowage devices, more particularly to an apparatus to stow sockets, socket wrenches, and extensions for immediate use.

### 2. Description of Related Art

All machine and repair shops fight an almost constant battle against clutter and keeping tools neatly organized and available for instant use. Small tools are especially prone to being misplaced and/or left laying about as mechanics perform their repair or assembly task. Almost inevitably, small tools and components get misplaced or lost, costing precious work time lost as mechanics search for a needed tool.

Socket wrenches and their sockets can be particularly problematic. Every shop, big or small, faces a similar problem; lack of organization for their sockets. Traditionally, sockets are organized on a rail socket holder. These rail socket holders are often flimsy and difficult to utilize. This often results in a drawer with loose sockets, time wasted looking for the correct size socket for each task, and frustration.

Based on the foregoing, there is a need in the art a system, which will facilitate easily storing and organizing socket wrench sets and save wasted time due to searching for the right socket.

### SUMMARY OF THE INVENTION

A socket tool storage system comprises a multi-tiered arrangement of a plurality of socket shelves in a vertical configuration, each socket shelf comprised of a plurality of socket drive attachments to receive sockets, with non-identical spacing between the drive attachments. A central shaft facilitates attaching the socket shelves in the vertical configuration, one socket shelf over a next socket shelf, with each socket shelf attached to rotate on the central shaft. A ratchet and extension holder attached to the central shaft to stow a plurality of ratchets and extensions, the ratchet and extension holder comprising holes of at least two diameters. A back shroud attached to a base, the base supporting the central shaft.

The central shaft comprises a central all thread rod covered with a length of steel pipe, and each socket shelf comprises a centrally located friction fitted ball bearing mounted to the central shaft to rotate around the all thread rod secured to the central shaft using two nuts, one on the under side of the socket shelf and one on the upper side, tightened in opposition to pinch against an inner race of the ball bearing allowing each of the plurality of socket shelves to rotate.

The socket shelves comprise a circular first socket shelf of approximately 9″ in diameter, a circular second socket shelf of approximately 7″ in diameter, and a circular third socket shelf of approximately 5¼′ in diameter.

The socket shelves comprise a first socket shelf with ½″ drive attachments, a second socket shelf with ⅜″ drive attachments, and a third socket shelf with ¼″ drive attachments.

The socket shelves comprise safety grade Plexiglas®.

The central shaft includes a base rotatable 90° for mounting.

The base mount can attach to a wall or a work bench.

The socket tool storage system further comprises a safety cap on an upper end of the central shaft.

The drive attachments are arranged around the circumference of the socket shelves.

Advantages:

1. Improved organization.

2. Improved work flow.

3. Improved mechanical stability over other designs.

4. Improved access to frequently-used tool components.

5. Reduced time spent searching for the correct wrench socket.

The invention neatly organizes sockets for use. It allows easy access and makes it easy to identify and access the exact socket needed. The invention uses three levels of socket organization, starting at the top with ¼″ drive, the middle with ⅜″ drive, and the bottom with ½″ drive in three socket shelves. It also includes a holding rack for the ratchets and extensions with ¼, ⅜, and ½ inch sizes. It also holds extensions for the ratchets and extensions. Each level of the invention spins 360° for easy access to the sockets. The invention's design allows proper space between each socket to display each socket size smallest to largest. The invention is equipped with a mount to be securely attached to a wall or work bench. The base can be enclosed by a back guard to protect from other surrounding objects that could obstruct rotation of the socket shelves holding the sockets. The back guard also catches any dropped socket and enables the effortless retrieval of sockets.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a front perspective view of the socket tool storage system, according to an embodiment of the present invention;

FIG. 2A-C is a top view of the three socket shelves, according to an embodiment of the present invention;

FIG. 3 is a top view of the generic socket shelf, according to an embodiment of the present invention;

FIG. 4 is a top perspective view of the ball-bearing, according to an embodiment of the present invention;

FIG. 5 is top perspective view of the central shaft assembly, according to an embodiment of the present invention;

FIG. 6 is front view of the socket tool storage system including stowed tools, according to an embodiment of the present invention; and

FIG. 7 is a back view of the socket tool storage system, according to an embodiment of the invention.

### DETAILED DESCRIPTION OF PREFERRED EMBODIMENTS

Preferred embodiments of the present invention and their advantages may be understood by referring to FIGS. 1-7, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows a front perspective view of the socket tool storage system 100 in an embodiment of the invention. Three individual rotating socket shelves 105 can be circular shaped and can accommodate a plurality of sockets around the circumference of each shelf. In an embodiment, you can have three rotating socket shelves 105 arranged in a three tier stack with each tier able to individually rotate. A Plexiglas® or hard, durable plastic ratchet and extension holder 110 can be positioned at the bottom of the socket tool storage system 100. The socket shelves 105 can be constructed of the same material. Plexiglas®—poly(methyl methacrylate) (PMMA)—also known as acrylic or acrylic glass, is a lightweight or shatter-resistant alternative to glass and offers good tensile strength, flexural strength, transparency, polishability, and UV tolerance. Other high impact, durable plastics can be used in addition to Plexiglas®. Two different sized stowage holes 115 and 120 can be placed in the ratchet and extension holder 110. The smaller extension storage holes 115 can be used to stow socket extensions, while the larger ratchet storage holes can be used to stow ratchets 120. As depicted, the ratchet and extension holder 110 does not rotate, but in other alternate embodiments may be configured to rotate.

In an embodiment, each of the socket shelves 105 can include a plurality of drives 125 around the circumference onto which each socket can lock. The drives can be made of steel in sizes ¼″, ⅜″, and ½″ sizes to standard socket wrench sizes and accommodate both inch and metric patterns. Central shaft 130 connects the components of the socket tool storage system 100, securing the individual rotating socket shelves 105 in a vertical, three-tier configuration, and can consist of a ¼″ all thread rod (not shown) covered by ⅜″ diameter steel pipe slid over the ¼″ all thread rod. In an embodiment, each of the socket shelves 105 are secured to the central shaft 130 using rotating 1″ ball bearings friction fitted to each of the socket shelves 105. A hard plastic safety cap 140 can be mounted to the top of the ¼″ all thread rod at the top of central shaft 130 to protect the user from possible injury. A hard plastic back shroud 145 can all be attached to the base of the central shaft 130. The central shaft 130 and ¼″ all thread rod can be secured to a base 150 made from wood. Other materials such as plastic or metal can be used for the base 150, and the base may provide for securing to a work table.

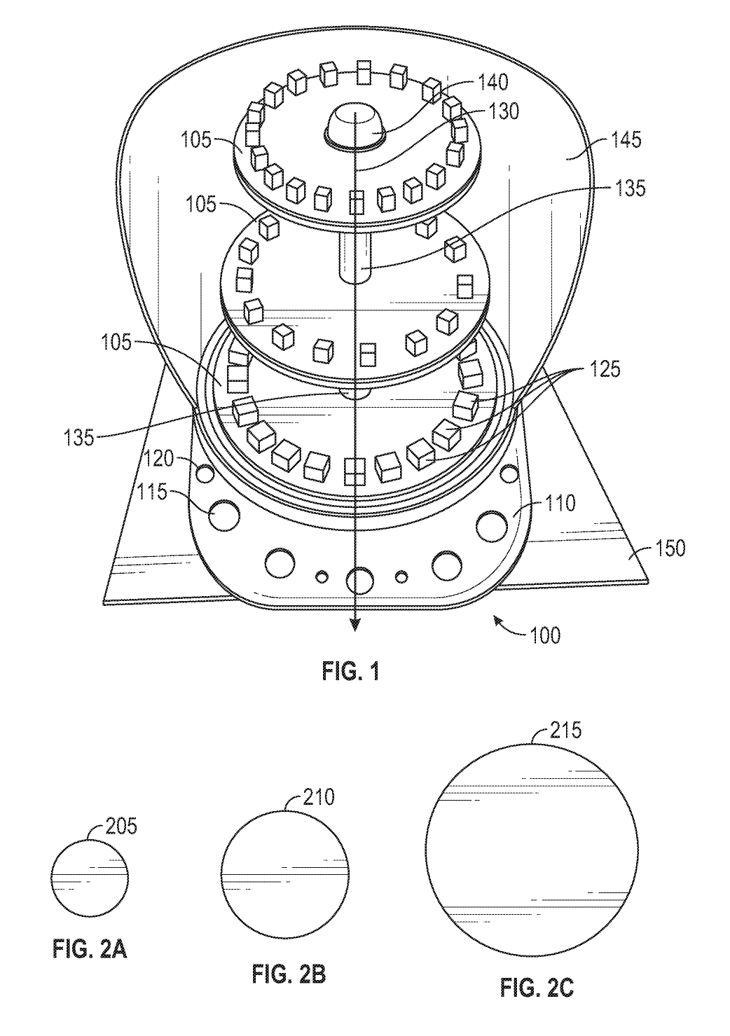

FIG. 2A-C is a top view of embodiments of the three socket shelves 105. Socket shelf 205 can comprise an approximately 5¼″ diameter circular member accommodating 20 drives for receiving individual ¼″ sockets. Socket shelf 210 can comprise an approximately 7″ diameter circular member accommodating 15 drives for receiving individual ⅜″ sockets. Socket shelf 215 can comprise an approximately 9″ diameter circular member accommodating 18 drives for receiving individual ½″ sockets.

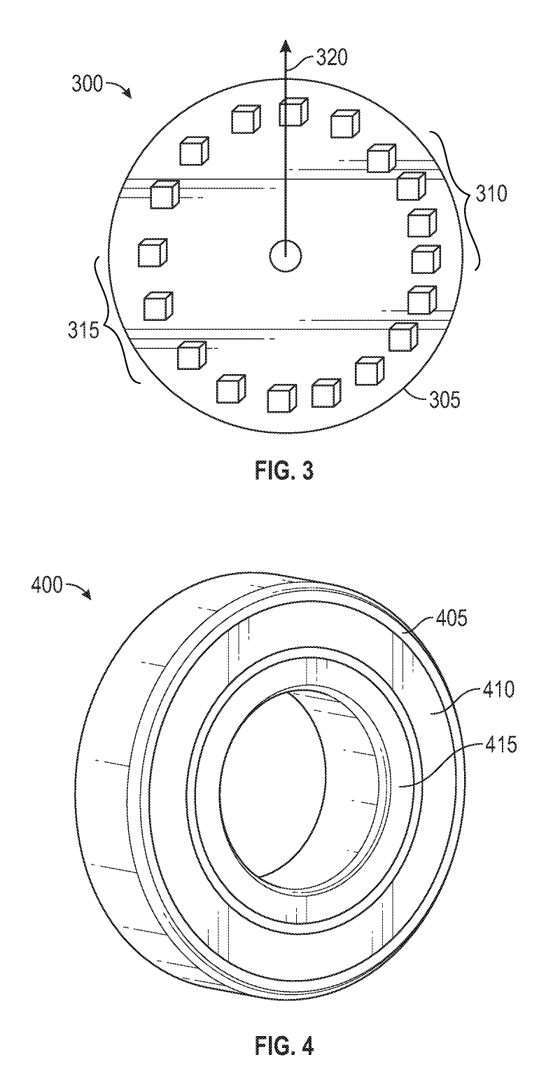

FIG. 3 is a top view of a generic embodiment of a socket shelf 300. The socket shelf 300 can comprise a circular body 305, and the circular body 305 can include multiple drives 310 and 315. Plurality of drives 310 can be attached and spaced closer together to accommodate large-sized sockets, and plurality of drives 315 can be attached and spaced closer together to accommodate small-sized sockets. Each drive 310 and 315 can include a lock mechanism to engage an attached socket securing the socket to the drive 310 and 315. A center hole 320 can receive a friction-fitted ball bearing facilitating securing a ball bearing in place. Each socket shelf 205, 210, and 215 can follow this general configuration. The socket shelf 300 and back shroud 145 can comprise ⅜″ thick safety grade Plexiglas®.

FIG. 4 is a top perspective view of a ball-bearing 400 in an embodiment. Ball bearing 400 can comprise an outer race 405 onto which a Plexiglas® socket shelf 300 can friction fit up against. Ball bearing 400 can further include a plurality of balls positioned in an inner ring 410 and an inner race 410. The inner race 410 can accommodate the ¼″ all thread rod 130, which can be secured in place with a nut on the top and the bottom squeezing tight against the inner race 410.

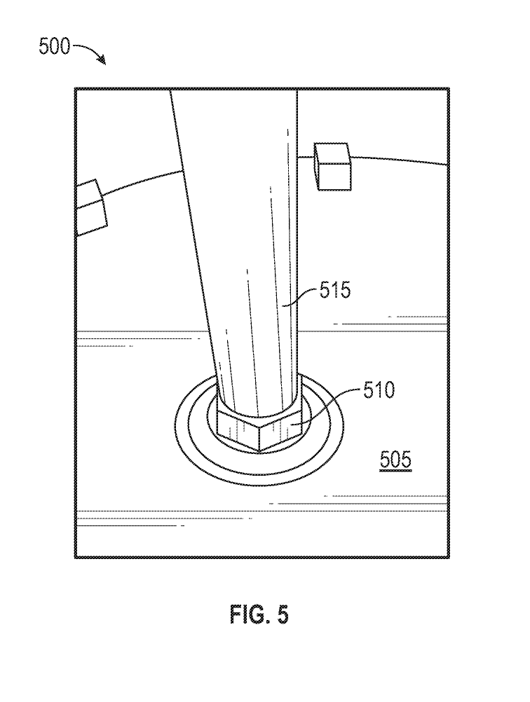

FIG. 5 is a top perspective view of a central shaft assembly 500. Socket shelf assembly 500 includes a socket shelf 505. Socket shelf 505 can include ball bearing 400 (not shown) secured by a 9/16″ nut 510. A ⅜″ steel pipe 515 fits over the ¼″ all thread rod (not shown) to which the socket shelf 505 can be secured. Nut 510 can include a matching 9/16″ nut (not shown) on the opposite side of socket shelf 505 also on the ¼″ all thread rod so that when both nuts 510 are tightened down against the ball bearing 400 to pinch against the inner race 415 and allow the socket shelf 505 to freely rotate around the all thread rod and steel pipe 515.

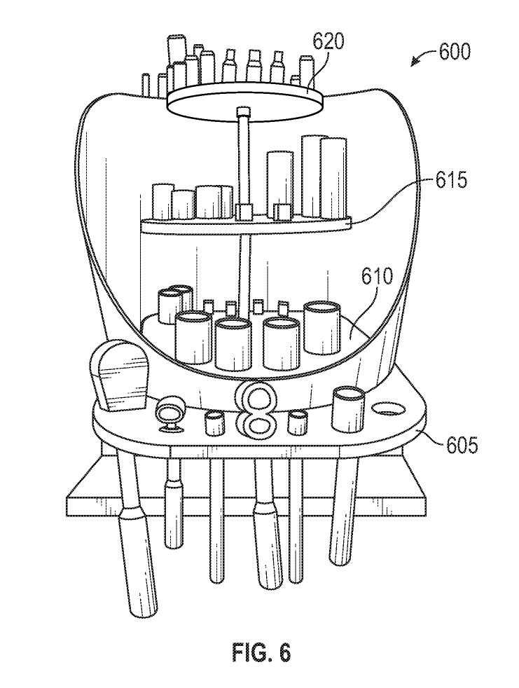

FIG. 6 is a front view of a socket tool storage system 600 including stowed tools. Socket tool storage system 600 can include a ratchet and extension holder 605 stowing ratchets and extensions, a ¼″ socket shelf 610 stowing ¼″ sockets, a ⅜″ socket shelf 615 stowing ⅜′ sockets, and a ½″ socket shelf 620 stowing ½″ sockets. In use, the drives can stow metric size sockets of approximately ¼″, ⅜″, and ½″.

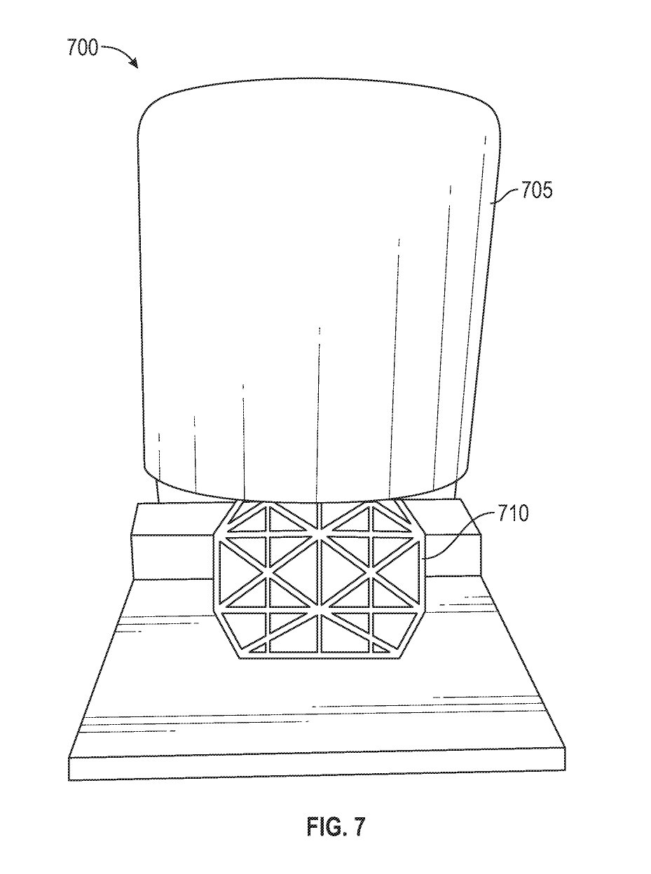

FIG. 7 is a back view of the socket tool storage system 700. Plastic back shroud 705 can form back of socket storage system 700. A mount 710 can be mounted to a wall or a bench and can rotate up to 90°

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A socket tool storage system, comprising:
a multi-tiered arrangement of a plurality of socket shelves in a vertical configuration, each socket shelf comprised of a plurality of socket drive attachments to receive sockets, with non-identical spacing between the drive attachments;
a central shaft facilitating attaching the socket shelves in the vertical configuration, one socket shelf over a next socket shelf, with each socket shelf attached to rotate on the central shaft;
a ratchet wrench and extension holder attached to the central shaft to stow a plurality of ratchets and extensions, the ratchet and extension holder comprising holes of at least two diameters.

2. The socket tool storage system of claim 1, wherein the central shaft comprises a central all thread rod covered with a length of steel pipe, and wherein each socket shelf comprises a centrally located friction fitted ball bearing mounted to the central shaft to rotate around the all thread rod secured to the central shaft using two nuts, one on the under side of the socket shelf and one on the upper side, tightened in opposition to pinch against an inner race of the ball bearing allowing each of the plurality of socket shelves to rotate.

3. The socket tool storage system of claim 1, wherein the socket shelves comprise a circular first socket shelf of approximately 9″ in diameter, a circular second socket shelf of approximately 7″ in diameter, and a circular third socket shelf of approximately 5¼′ in diameter.

4. The socket tool storage system of claim 1, wherein the socket shelves comprise a first socket shelf with ½″ drive attachments, a second socket shelf with ⅜″ drive attachments, and a third socket shelf with ¼″ drive attachments.

5. The socket tool storage system of claim 1, wherein the socket shelves comprise safety grade Plexiglas®.

6. The socket tool storage system of claim 1, wherein the central shaft includes a base mount rotatable 90° for mounting.

7. The socket tool storage system of claim 6, wherein the base mount can attach to a wall or a work bench.

8. The socket tool storage system of claim 1, further comprising a safety cap on an upper end of the central shaft.

9. The socket tool storage system of claim 3, wherein the drive attachments are arranged around the circumference of the socket shelves.

10. The socket tool storage system of claim 1, further comprising a back shroud attached to a base, and the base supporting the central shaft.
